(19) United States
(12) Patent Application Publication
(10) Pub. No.: US 2026/0169493 A1
(43) Pub. Date: Jun. 18, 2026

(54) ATTENTION-BASED MAP ENCODING FOR GENERALIZED ROBOT LOCOMOTION

(71) Applicants: DISNEY ENTERPRISES, INC., Burbank, CA (US); ETH Zürich (Eidgenössische Technische Hochschule Zürich), Zürich (CH)

(72) Inventors: Ruben Jelle GRANDIA, Zürich (CH); Chong ZHANG, Zürich (CH); Junzhe HE, Zürich (CH); Marco HUTTER, Oberriet-Kriessern (CH); Fabian Pasqual JENELTEN, Ergisch (CH); Moritz Niklaus BÄCHER, Zürich (CH)

(21) Appl. No.: 19/417,245

(22) Filed: Dec. 11, 2025

Related U.S. Application Data
(60) Provisional application No. 63/733,178, filed on Dec. 12, 2024.

(51) Int. Cl. G05D 1/646; G06N 3/008

(52) U.S. Cl. CPC G05D 1/646; G06N 3/008

(57) ABSTRACT

The present invention sets forth techniques for generating robot action commands directed to robot locomotion. The techniques include encoding map scans representing terrain and proprioception data representing a current state of a robot. The techniques also include generating point-wise map features based on the encoded map scan, and transmitting the map features to a multi-head attention (MHA) mechanism. The MHA mechanism assigns an attention weight to each of multiple terrain points included in the map features, conditioned on the proprioception data. The MHA mechanism generates a map encoding representing the terrain points and their corresponding attention weights, where higher attention weights are associated with terrain points that may provide suitable footholds for the robot. Based on a concatenation of the map encoding and the proprioception data, a multilayer perceptron (MLP) generates robot action commands, such as joint movement commands, causing the robot to traverse the terrain.

### CROSS-REFERENCE TO RELATED APPLICATIONS

This application claims priority benefit to U.S. Provisional application titled “ATTENTION-BASED MAP ENCODING FOR GENERALIZED ROBOT LOCOMOTION,” filed on Dec. 12, 2024, and having Ser. No. 63/733,178. The subject matter of this related application is hereby incorporated herein by reference.

### BACKGROUND

### Field of the Various Embodiments

Embodiments of the present disclosure relate generally to machine learning and robot locomotion and, more specifically, to techniques for implementing attention-based map encoding for generalized robot locomotion.

### Description of the Related Art

In the field of mobile robots, legged robots may be better suited to navigating rough, uneven, broken, or otherwise irregular terrain compared to other types of mobile robots such as wheeled or tracked robots. Further, legged robots may cause less damage or erosion to terrain compared to wheeled or tracked robots.

Successful terrain navigation requires that a legged robot calculate suitable locations within the terrain to place its feet. A suitable location for foot placement, or foothold, may include a location that will enable the robot to progress toward a specified goal while also enabling the robot to maintain and/or recover its balance during locomotion.

Existing techniques for robot locomotion may include one or more machine learning models trained in an end-to-end manner using a deep reinforcement learning (DRL) technique. While these methods may demonstrate adequate robustness against uncertainty and noise included in the model inputs, one drawback of these techniques is that the models may struggle to identify valid footholds on sparse terrain or learn from the identified footholds.

Existing techniques may include other machine learning model-based strategies, such as model predictive control (MPC). These techniques may solve optimal robot control problems over a long time horizon, allowing the techniques to identify valid footholds, even in sparse terrain. One drawback of these techniques is that they may rely on one or more assumptions, such as perfect robot state estimation, perfect and complete map information, and simplified dynamic and kinematic models. These assumptions may lead to degraded performance under model-mismatch, drifting robot state estimation, and/or imprecise motor actuation.

Still other techniques may combine deep reinforcement learning and model-based strategies, such as using deep reinforcement learning techniques to identify footholds that are then tracked with model-based controllers. While these techniques may outperform either DRL or MPC strategies used alone, they are still subject to the deficiencies of MPC-based techniques, specifically fragility when presented with imperfect information regarding, e.g., map data, robot state estimation, and/or dynamic or kinematic models.

As the foregoing illustrates, what is needed in the art are more effective techniques for controlling dynamic robot locomotion in diverse and challenging environments.

### SUMMARY

One embodiment of the present invention sets forth a technique for generating robot action commands. The technique includes generating embedded map features based at least on a three-dimensional (3D) representation of a terrain and generating a query based at least on robot proprioception data. The technique also includes generating, using multi-head attention and based at least on the query and the embedded map features, attention weights associated with a plurality of terrain points included in the terrain, and generating one or more robot action commands based at least on the attention weights and the robot proprioception data.

One technical advantage of the disclosed techniques relative to the prior art is that the disclosed techniques generate robot actions that enable a robot to dynamically navigate diverse terrain types, including terrains that include sparsely distributed footholds. The disclosed techniques are also operable to generate precise robot behaviors in novel scenarios, while exhibiting robustness against uncertain inputs and/or environmental conditions. These technical advantages provide one or more improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computer system configured to implement one or more aspects of various embodiments of the present invention.

FIG. 2 is a more detailed illustration of the controller of FIG. 1, according to some embodiments.

FIG. 3 is a more detailed illustration of the encoder of FIG. 2, according to some embodiments.

FIG. 4 illustrates a system configured to fine-tune the controller of FIG. 1, according to some embodiments.

FIG. 5 is a flow diagram of method steps for fine-tuning a controller to generate robot actions, according to some embodiments.

FIG. 6 is a depiction of a robot and an associated environment, according to some embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

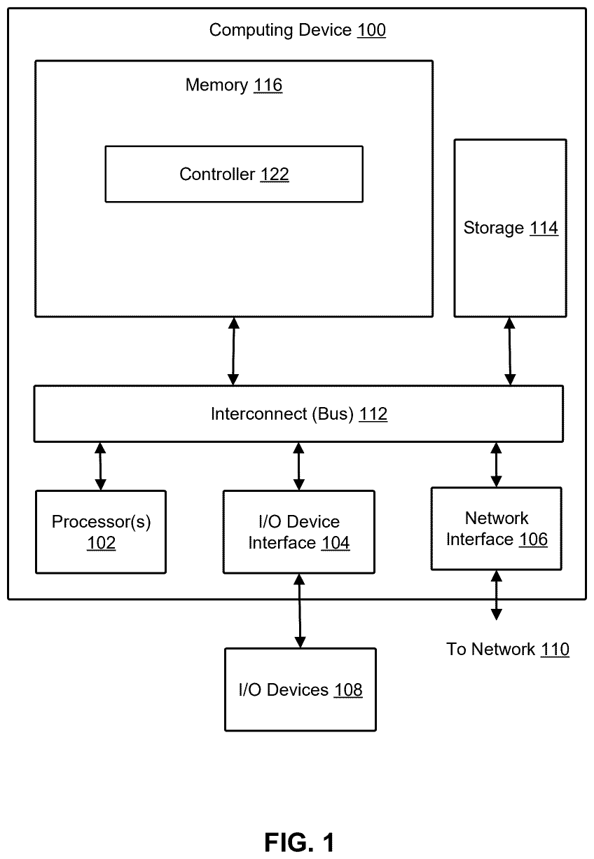

FIG. 1 illustrates a computing device 100 configured to implement one or more aspects of various embodiments of the present invention. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run a controller 122 that resides in a memory 116.

It is noted that the computing device described herein is illustrative and that any other technically feasible configurations fall within the scope of the present disclosure. For example, multiple instances of controller 122 could execute on a set of nodes in a distributed and/or cloud computing system to implement the functionality of computing device 100. In another example, controller 122 could execute on various sets of hardware, types of devices, or environments to adapt controller 122 to different use cases or applications. In a third example, controller 122 could execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, a microphone, and so forth, as well as devices capable of providing output, such as a display device or speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a robotics engineer) of computing device 100, and to also provide various types of output to the end-user of computing device 100, such as displayed digital images, digital videos, or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (Wi-Fi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Controller 122 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including controller 122.

### Robot Action Inference

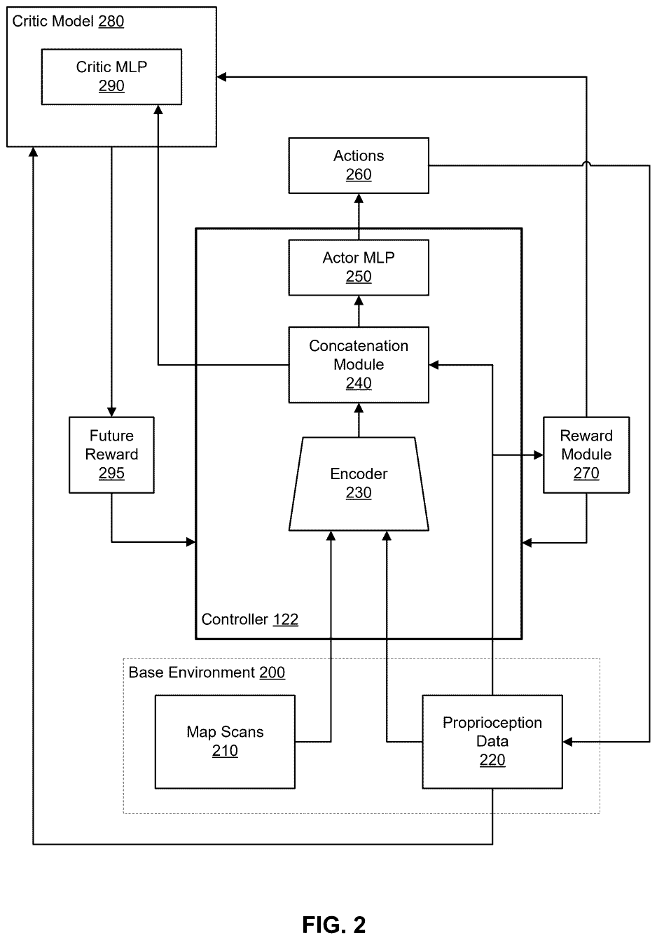

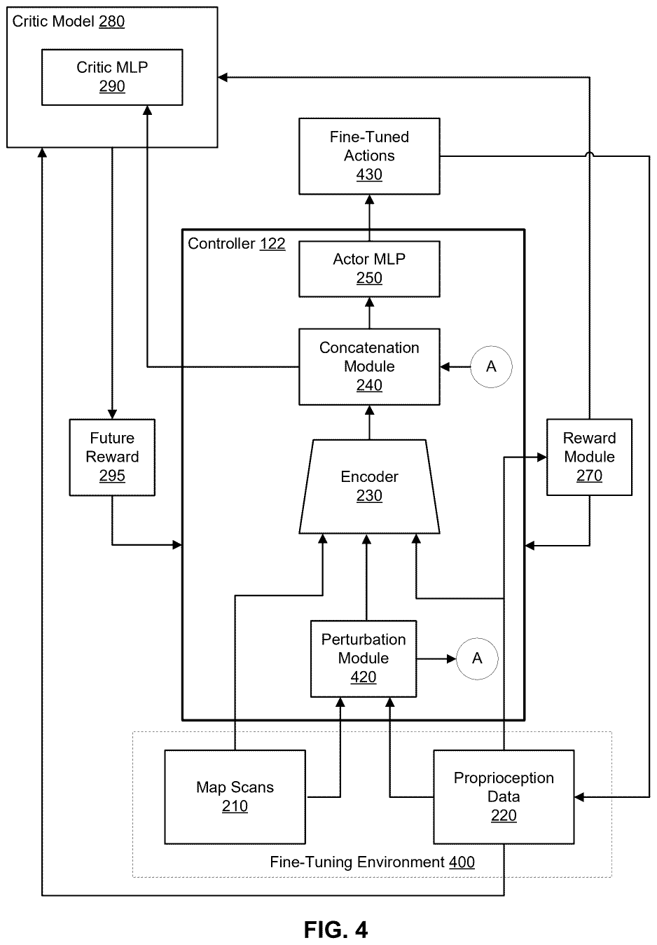

FIG. 2 is a more detailed illustration of controller 122 of FIG. 1, according to some embodiments. Controller 122 receives input data associated with base environment 200, including map scans 210 and proprioception data 220. Controller 122 generates actions 260 to direct the dynamic locomotion of a robot. Critic model 280 includes critic multilayer perceptron (MLP) 290 that predicts future reward 295 based on proprioception data 220. Various components within controller 122 may be trained and/or fine-tuned based on one or more of proprioception data 220, future reward 295, and values generated by reward module 270. Controller 122 includes, without limitation, encoder 230, concatenation module 240, and actor MLP 250. In various embodiments, controller 122 also includes perturbation module 420. In these embodiments, perturbation module 420 is used during a second stage of training as shown and discussed in FIG. 4 and the detailed description of FIG. 4, respectively. Accordingly, perturbation module 420 is omitted from FIG. 2 for purposes of clarity.

In various embodiments, map scans 210 may include simulated or real-world location information associated with terrain in the vicinity of a robot. Simulated location information may be based on, e.g., a rendering or other depiction of a virtual three-dimensional (3D) environment. Real-world location information may be generated based on one or more sensors included in the robot and/or situated within the robot's environment. Sensors may include, but are not limited to, RADAR, SONAR, LIDAR, ultrasonic, or visual camera-based sensors. In various embodiments, map scans 210 may include simulated location information associated with a variety of different simulated terrains used to train controller 122 as discussed in more detail herein.

In various embodiments, map scans 210 may be expressed as a collection of terrain points, where each point includes an associated 3D location within an environment. For example, a map scan may include an (L×W) grid of terrain points, and each point may include x, y, and z coordinates associated with the terrain point. In various embodiments, the robot may be centered within the (L×W) grid of terrain points, and the x, y, and z coordinates associated with each terrain point may be expressed in a 3D coordinate system centered on the robot. These examples are not intended to be limiting, and embodiments are contemplated in which the terrain point locations and/or terrain point coordinates may be expressed in any suitable coordinate system. In various embodiments, the robot may not be centered within the (L×W) grid. For example, a greater number of the (L×W) terrain points may be located in front of the robot compared to a number of terrain points located behind the robot. The dimensionality of a map scan included in map scans 210 may be expressed as (L×W×3), representing the length of the grid as a number of terrain points L, the width of the grid as a number of terrain points W, and the three positional x, y, and z coordinates associated with each terrain point.

In various embodiments, proprioception data 220 includes real and/or simulated observations associated with the robot's state, including motion, orientation, external robot commands, and previous actions. For example, proprioception data 220 may include, for a given time step t, linear velocities, angular velocities, and/or a gravity vector associated with the robot. Proprioception data 220 may also include positions and velocities associated with each of multiple joints and/or limbs included in the robot at time t, as well as received external commands used to control the robot, such as commanded linear and/or angular velocities. Proprioception data 220 may further include previous robot actions 260 inferred by controller 122, such that at a time t, proprioception data 220 may include robot actions that were inferred for time step t-1. The dimensionality of proprioception data 220 at a given time step t may be expressed as d_obs, where obs refers to observations included in proprioception data 220. Map scans 210 and proprioception data 220 collectively form base environment 200, where map scans 210 may comprise descriptions of a variety of basic terrain types used to train controller 122 as described herein.

In various embodiments, encoder 230 receives map scans 210 and proprioception data 220 associated with a real or simulated time t. Encoder 230 generates an attention-weighted map encoding associated with the robot's environment, based on map scans 210 and conditioned on proprioception data 220.

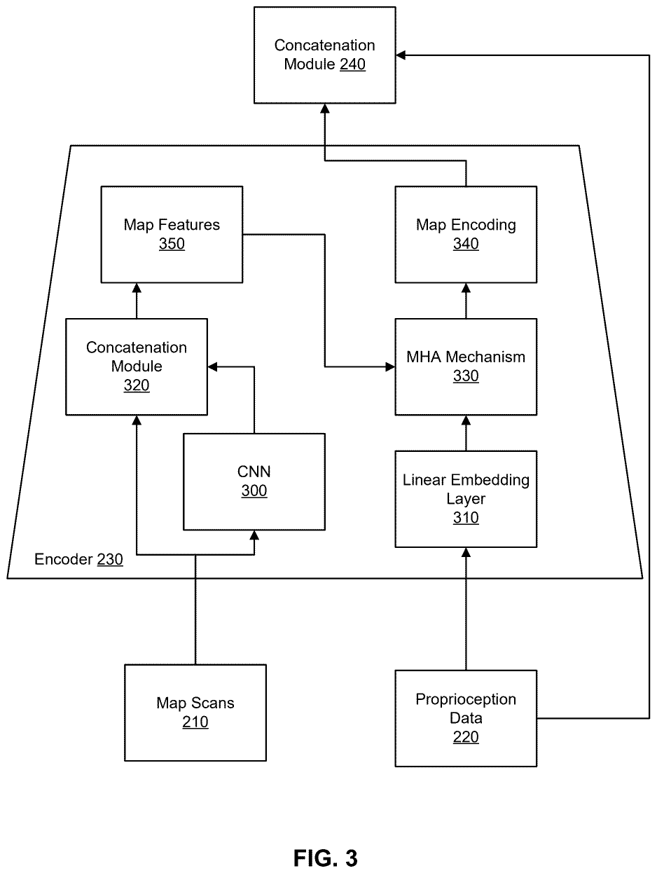

Turning now to FIG. 3, FIG. 3 is a more detailed illustration of encoder 230 of FIG. 2, according to some embodiments. As discussed herein, encoder 230 receives map scans 210 and proprioception data 220, and generates map encoding 340. Encoder 230 transmits map encoding 340 to concatenation module 240. Encoder 230 includes, without limitation, convolutional neural network (CNN) 300, concatenation module 320, map features 350, linear embedding layer 310, and multi-head attention (MHA) mechanism 330.

In various embodiments, encoder 230 receives a scan from map scans 210 having a dimensionality (L×W×3), as discussed herein. Encoder 230 transmits the received scan at its full dimensionality to concatenation module 320. Encoder 230 also transmits a reduced version of the map scan to CNN 300, where the reduced version of the map scan discards the x and y coordinate values for each terrain point in the (L×W) grid of terrain points, retaining only the z coordinate (height) associated with each terrain point. Consequently, the dimensionality of the reduced version of the map scan is (L×W×1).

In various embodiments, CNN 300 receives the reduced version of the map scan included in map scans 210 and embeds point-wise local terrain features in a robot-centric elevation map derived from the reduced, height-only version of the map scan. In various embodiments, CNN 300 may include a two-layer convolutional network incorporating zero padding to maintain the original (L×W) dimensionality, and a kernel size, e.g., five, sufficient to enable CNN 300 to extract local terrain features associated with a point included in the (L×W) grid. The dimensionality of the robot-centric elevation map generated by CNN 300 may be based on a dimensionality d associated with MHA mechanism 330 discussed herein, such that the dimensionality of the robot-centric elevation map generated by CNN 300 may be (L×W×(d−3)). For example, in an embodiment that includes an MHA mechanism 330 having a dimensionality d=64, the dimensionality of the robot-centric elevation map generated by CNN 300 may be (L×W×61). CNN 300 transmits the robot-centric elevation map to concatenation module 320.

In various embodiments, concatenation module 320 receives the full-dimensionality (L×W×3) map scan from map scans 210 and the robot-centric elevation map having a dimensionality (L×W×(d−3)) from CNN 300. Concatenation module 320 combines the full-dimensionality map scan and the robot-centric elevation map to generate map features 350.

In various embodiments, map features 350 include feature embeddings and 3D coordinate locations associated with each terrain point included in the (L×W) grid of terrain points. Each terrain point included in map features 350 includes the x, y, and z coordinates associated with the terrain point and having a combined dimensionality of three. Each terrain point included in map features 350 also includes the point-wise embedded local terrain features generated by CNN 300, where the embedded terrain features associated with each point include a dimensionality of d−3. Accordingly, the dimensionality of map features 350 is (L×W×d). Encoder 230 transmits map features 350 to MHA mechanism 330. In various embodiments, encoder 230 transmits map features 350 to MHA mechanism as key-value pairs, where a terrain point included in the (L×W) grid of terrain points represents a value, and the d-dimensional local feature embeddings associated with the terrain point represent a corresponding key.

In various embodiments, linear embedding layer 310 receives proprioception data 220 and generates a query for transmittal to MHA mechanism 330. Linear embedding layer 310 may generate a query based on a dimensionality d and a query length n associated with MHA mechanism 330. As described herein, the dimensionality d of MHA mechanism 330 may equal 64. The query length n describes how many time steps of robot state data linear embedding layer 310 receives from proprioception data 220 and transmits to MHA mechanism 330, where each time step of robot observational data includes d_obs values, as discussed herein. For example, in an embodiment where n=1, linear embedding layer 310 may receive proprioception data 220 having a dimensionality of (n×d_obs), or (1×d_obs). Based on the dimensionality d and query length n associated with MHA mechanism 330, linear embedding layer may generate a query Q having a dimensionality of (n×d). As discussed herein, proprioception data 220 comprises information associated with a robot state, including but not limited to positions, motions, external commands, and prior actions associated with the robot. After linear embedding layer 310 converts proprioception data 220 from a dimensionality of (n×d_obs) into a query Q, the resulting query Q represents robot-centric proprioception data for a current time step and is used to condition the operation of MHA mechanism 330. Linear embedding layer 310 transmits the query Q to MHA mechanism 330.

In various embodiments, MHA mechanism 330 receives map features 350 as key-value pairs, and the query Q representing robot proprioception data (hereinafter “robot proprioception query Q”). Based on the robot proprioception query Q and the key-value pairs, MHA mechanism 330 generates map encoding 340.

As discussed herein, MHA mechanism 330 may include an associated dimensionality d. Continuing from previous examples, in some embodiments, d may be equal to 64. MHA mechanism 330 may also include an associated number h of attention heads, e.g., h=4, such that each attention head processes a quantity (d/h) of dimensions included in the input. As discussed herein, MHA mechanism 330 may also include an associated query length n, e.g., 1.

In various embodiments, the dimensionality of map features 350 transmitted to MHA mechanism 330 may be (L×W×d), while the robot proprioception query Q may include a dimensionality (n×d). In these embodiments, map encoding 340 generated by MHA mechanism 330 may include a dimensionality of (n×d).

Map encoding 340 includes embedded features describing terrain points included in an environment, as well as an amount of attention paid to each terrain point by MHA mechanism 330. As discussed herein, map features 350 are transmitted to MHA mechanism 330 as key-value pairs, where a value represents a terrain point within the robot's surroundings and a key represents local terrain features associated with the corresponding value. For each value (terrain point) included in map features 350, MHA mechanism 330 calculates an associated attention weight for inclusion in map encoding 340, where an attention weight associated with a value is based on the compatibility or relevance of the robot proprioception query Q with the key corresponding to the value. An attention weight associated with a value (terrain point) therefore represents the amount of attention paid to the terrain point by MHA mechanism 330, conditioned on the current robot state and robot action history included in proprioception data 220 and encoded in robot proprioception query Q. Encoder 230 transmits the generated map encoding 340 to concatenation module 240.

Returning to FIG. 2, concatenation module 240 receives map encoding 340 and proprioception data 220. Concatenation module 240 combines map encoding 340 and proprioception data 220, and transmits the combination to actor MLP 250 and critic model 280 discussed herein. In various embodiments, the dimensionality of proprioception data 220 is (n×d_obs) and the dimensionality of map encoding 340 is (n×d). In these embodiments, the dimensionality of the output generated by concatenation module 240 and transmitted to actor MLP 250 will therefore be (n×(d+d_obs)).

In various embodiments, actor multilayer perceptron (MLP) 250 receives input data from concatenation module 240 and generates one or more actions 260 based on the input data, where actions 260 include movement commands directed to a robot. After training, actor MLP 250 represents a policy module associated with the robot, and generates action(s) 260 for the robot conditioned on both an attention-weighted map encoding of a terrain and proprioception data associated with the robot. Actor MLP 250 identifies a suitable terrain foothold based on the attention-weighted map encoding and the robot proprioception data, and generates action(s) 260 causing the robot to modify its current position and/or movement to place (or progress toward placing) one or more limbs on the identified terrain foothold. In various embodiments, controller 122 may also transmit action(s) 260 to proprioception data 220 for inclusion in proprioception data 220 associated with one or more future time steps.

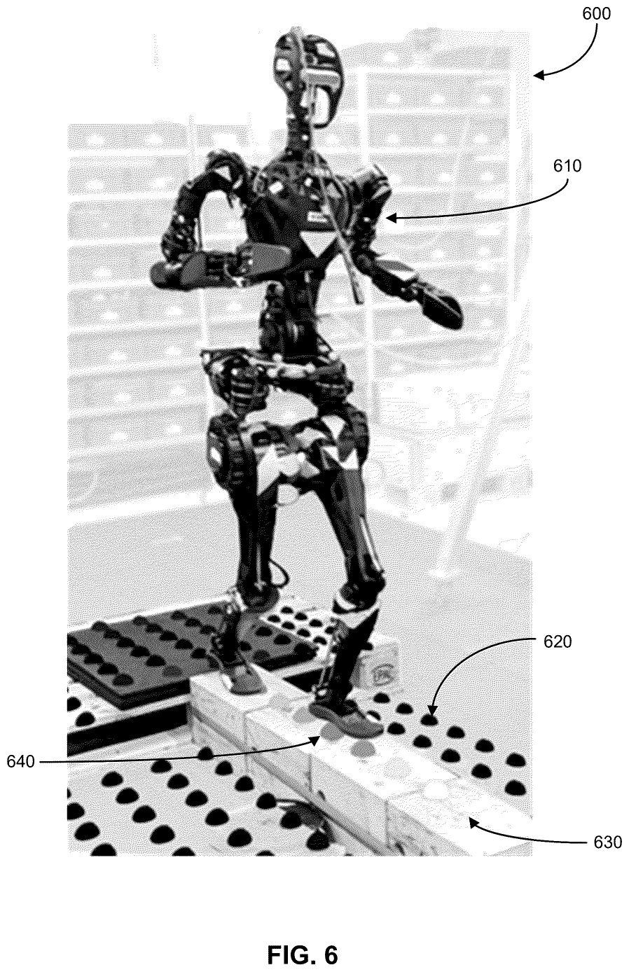

Turning now to FIG. 6, FIG. 6 is a depiction of a robot 610 and an associated environment 600, according to some embodiments. Environment 600 further includes, without limitation, terrain associated with the environment, such as elevated beam 630, and attention indicators 620 and 640.

In various embodiments, the depiction of environment 600 and its contents may provide a visual representation of robot 610 as it transits terrain included in environment 600. The depiction may also provide visual indications of the amount of attention paid to individual terrain elements, allowing users to monitor and/or evaluate the operation of MHA mechanism 330 during robot locomotion. Although FIG. 6 depicts environment 600 and its contents as a perspective view from a viewpoint exterior to the robot, this depiction is not intended to be limiting, and other methods of visualizing environment 600 are contemplated. Other visualization methods may include a first-person view from the robot's position or one or more orthographic views, such as top-down, side, or frontal views.

Elements included in environment 600, such as robot 610, beam 630, and other terrain elements may be depicted as 3D renderings of virtual environment models. In these embodiments, attention indicators 620 and 640 may be superimposed or otherwise incorporated into the 3D renderings. Additionally or alternatively, environment 600, robot 610, and/or terrain elements may be viewed as a live or recorded image or video presentation generated by, e.g., one or more cameras. In these embodiments, attention indicators 620 and 640 may be rendered as overlays within environment 600 to construct an augmented reality (AR) presentation of environment 600 and its associated contents.

In various embodiments, robot 610 may include a bipedal humanoid robot, although this is not intended to be limiting. Other embodiments may include different types of robots, each having a different number and/or configuration of legs. Robot 610 may include an associated number of degrees of freedom, where the number of degrees of freedom represents a number of independent movements that a robot may make. For example, a single joint may be operable to rotate in one direction independently of any linear motion associated with the joint, and may further be operable to move in any one or more of three linear directions independently of any rotation associated with the joint. In this example, the single joint would contribute four degrees of freedom (one rotational and three linear) to the robot associated with the joint. In various embodiments, robot 610 may include, e.g., 14 or 23 degrees of freedom, depending on the configuration of robot 610.

Terrain associated with environment 600 may include beam 630 having an associated elevation, as well as other terrain elements such as stepping stones, platforms, gaps, and/or pallets. Each terrain element may include one or more x, y, and z-coordinates describing the element's position within environment 600. The terrain associated with an instance of environment 600 may include an associated difficulty rating, where the difficulty rating may be based on the number, density, and/or locations of various terrain elements included in environment 600.

In various embodiments, the depiction of environment 600 includes attention indicators, such as attention indicators 620 and 640. In these embodiments, each attention indicator may be associated with a terrain point included in the (L×W) grid of terrain points. Each attention indicator may include one or more associated color, size, shape, brightness, or other differentiating characteristics based on an amount of attention paid to the associated terrain point by MHA mechanism 330 as discussed herein. As shown, attention indicator 620 is presented in black, indicating that MHA mechanism 330 focused little or no attention on the terrain point associated with attention indicator 620. In contrast, the various attention indicators associated with terrain points located on beam 630, such as attention indicator 640, are presented in various different colors and/or brightnesses representing varying amounts of attention paid to the corresponding terrain points. The color and/or brightness associated with attention indicator 640 may represent an amount of attention paid on an absolute scale of possible attention weights, or may be determined relative to other attention weights associated with the (L×W) grid of terrain points. The visual characteristics of the attention indicators are based on map encoding 340, which is in turn conditioned on robot proprioception data including robot movements, positions, orientations, and previous commanded actions 260. Accordingly, map encoding 340 may include higher attention weights associated with terrain points that are in front of the robot, or that lie along a projected robot path, as opposed to terrain points that do not lie along the projected robot path or that are not reachable based on the robot's current position, movement, and/or orientation.

### Multi-Stage Training-First Stage

Returning now to FIG. 2, various components included in controller 122, such as actor MLP 250 and CNN 300, linear embedding layer 310, and MHA mechanism 330 of encoder 230, may include adjustable parameters that may be configured to modify the operation of controller 122. In various embodiments, controller 122 may iteratively adjust the configurable parameters during a two-stage training pipeline based on one or more values calculated by reward module 270. Critic model 280 may also iteratively modify adjustable parameters included in critic MLP 290 during each stage of the training pipeline based on future reward 295, values generated by reward module 270, and proprioception data 220.

During a first training stage, controller 122 performs the role of an actor model and generates actions 260, while critic model 280 predicts future reward 295 based on the action(s) generated by the actor model. Future reward 295 may include a scalar value representing expected total rewards associated with future robot actions and/or states based on current observations, such as proprioception data 220. In various embodiments, the actor model and critic model 280 may share encoder 230 and concatenation module 240, while critic MLP 290 is independent of actor MLP 250.

During the first training stage, both the actor model and critic model 280 receive, at encoder 230, map scans 210 and proprioception data 220 that represent ground truth terrain and robot data, respectively, and do not include intentionally added noise, uncertainties, perturbations, or map offsets. These ground truth simulations therefore collectively represent perfect perception by the robot of, e.g., its surroundings, positions, movements, forces, and/or orientations.

In various embodiments, map scans 210 may include scans of relatively simple terrain, in terms of path complexity and/or density of suitable footholds. Each simulated map scan included in map scans 210 may be associated with a simulated terrain having a corresponding difficulty level measured on, e.g., a scale of 1 to 10. During training, a simulated robot is randomly assigned a simulated terrain. If the robot successfully traverses the simulated terrain, the robot may be assigned a different simulated terrain having a higher associated difficulty level. If, instead, the robot does not successfully traverse the simulated terrain, the robot may be assigned a different simulated terrain having a lower associated difficulty level. The first stage training may continue for a predetermined number of epochs, e.g., 18,000 epochs. Further, some embodiments of the present invention may instantiate a large number, e.g., 4,096, of simulated robots and train the simulated robots simultaneously via parallel execution of multiple processors and/or processing threads.

In various embodiments, reward module 270 calculates a weighted sum of multiple reward terms based on robot performance. Reward terms may be grouped into categories, such as task rewards, regulation rewards, and style rewards. For each reward term, reward module 270 calculates an associated value. For example, task reward terms for linear and angular robot velocities may be based on mean squared error differences between commanded and actual linear and/or angular velocities. Task reward terms may also include collision and/or termination penalties. A collision penalty may be based on a number of times that a specified robotic limb collides with the terrain, while a termination penalty may be based on an early termination of the robot's task if, e.g., the robot's torso collides with the terrain, or if the robot's torso is positioned in an untenable orientation.

In various embodiments, regulation reward terms may evaluate movements and/or positions associated with one or more robot joints, and may penalize drastic movements or extreme positioning of the robot joints. For example, regulation reward terms may include penalties based on summations of squared acceleration and/or torque values across multiple robot joints. Regulation reward terms may also penalize large changes in commanded robot joint actions based on mean squared differences between inferred robot actions associated with consecutive time steps. Regulation reward terms may also penalize one or more of commanded joint position, velocity, or torque values that exceed predetermined operating limits associated with the values.

In various embodiments, style reward terms may encourage natural robot movements and penalize unwanted movements, such as unwanted velocities, foot stomping, foot slippage, jumping gaits (i.e., commanded robot actions that cause all robot limbs to simultaneously lose contact with the terrain), or excessively tilted robot limbs. The style reward terms may penalize vertical linear velocity of the robot's torso, as well as angular velocity of the robot torso in the horizontal x-y plane. The style reward terms may also penalize an action in which the robot places too much of its weight on a single limb by comparing contact forces at each limb to a predetermined contact force limit.

Additional style reward terms may discourage jumping gaits by penalizing robot actions in which no robot limbs are in contact with the terrain. Reward module 270 may identify a jumping gait by determining that a summation of individual measured contact forces between each robot limb and the terrain is equal to zero or is less than a predetermined threshold. Reward module 270 may detect and penalize foot slippage, where foot slippage means that a limb is moving while in contact with terrain. A foot slippage penalty term may, for each robot limb, multiply the absolute value of the limb's velocity by a binary contact state. In various embodiments, a binary contact state value of 0 may indicate that the corresponding limb is not in contact with the terrain, while a binary contact state value of 1 may indicate that the corresponding limb is in contact with the terrain. The binary contact state value for a robot limb may be based, for example, on a position of an on/off microswitch associated with a contact surface included in the limb. Alternatively or additionally, in an embodiment that measures contact forces between robot limbs and terrain, a contact force measurement associated with a limb that exceeds zero or a predetermined threshold would correspond to a binary contact state value of 1 for the associated limb and indicate contact between the limb and the terrain.

In various embodiments in which robot 610 includes a bipedal humanoid robot, style reward terms may reward robot actions that result in a straight, upright robot body position. Reward module 270 may calculate gravity vectors associated with each of a bipedal robot's torso, pelvis, and feet. Given an upright robot standing body position with feet together, the gravity vectors will point straight down to reflect the Earth's gravity, and will align with one another, indicating that the centers of gravity associated with the robot's torso, pelvis, and feet are in a straight line. Any deviation from the upright standing position may incur a penalty based on the magnitude (or squared magnitude) of the deviation.

Various embodiments may include default joint positions associated with a standing orientation of a bipedal robot. Reward module 270 may penalize robot actions based on differences between measured and default joint positions. Reward module 270 may also penalize joint velocity values in a standing robot that differ from commanded velocity values intended to, e.g., maintain robot balance while standing.

Controller 122 may iteratively modify one or more adjustable parameters included in, e.g., encoder 230 or actor MLP 250 based on the weighted sum of reward terms calculated by reward module 270 and future reward 295 generated by critic MLP 290. Critic model 280 may also iteratively modify one or more adjustable parameters included in critic MLP 290 based on future reward 295, on or more values calculated by reward module 270, and/or proprioception data 220.

As discussed herein, both the actor model (controller 122) and critic model 280 act upon ground truth map scans 210 and proprioception data 220. Accordingly, the first stage of training enables baseline map encoding in encoder 230, baseline robot action policy formation in actor MLP 250, and future reward prediction in critic MLP 290 under perfect robot sensing conditions.

### Multi-Stage Training-Second Stage

FIG. 4 illustrates a system configured to fine-tune controller 122 of FIG. 1 and critic MLP 290 during a second stage of training, according to some embodiments. Controller 122 receives map scans 210 and proprioception data 220 from fine-tuning environment 400, where one or both of map scans 210 and proprioception data 220 may be modified by perturbation module 420 included in controller 122. Based on the modified map scans and/or the modified proprioception data, actor MLP 250 of controller 122 generates fine-tuned actions 430. Controller 122 may iteratively modify one or more adjustable parameters included in, e.g., encoder 230 or actor MLP 250 based on the weighted sum of reward terms calculated by reward module 270 and future reward 295 generated by critic MLP 290. Critic model 280 may also iteratively modify one or more adjustable parameters included in critic MLP 290 based on future reward 295, one or more values generated by reward module 270, and/or proprioception data 220.

Similar to the first stage training, the second stage training includes controller 122 performing the role of an actor model and critic model 280, each including the same architecture as described herein in reference to the first stage training. In the second stage training, critic model 280 may continue to act upon ground truth simulations of map scans 210 and proprioception data 220 as in the first stage training, where map scans 210 and proprioception data 220 include simulated map scans of various terrains and simulated robot proprioception data, such as robot positions, orientations, motions, and previous instances of fine-tuned actions 430.

The second stage training may introduce disturbances and uncertainties into map scans 210 and/or proprioception data 220 presented to the actor model. In various embodiments, perturbation module 420 may sample noise from a uniform noise distribution during each time step and add the sampled noise to each item of proprioception data 220 to generate modified proprioception data that simulates noisy or otherwise uncertain proprioception data. In some embodiments, the actor model may continue to receive ground truth proprioception data associated with external velocity commands and/or previously recorded robot actions, rather than modified commands and/or actions.

In various embodiments, each simulated map scan included in map scans 210 and presented to the actor model may include a positional offset assigned during second stage training. In various embodiments, perturbation module 420 may randomly sample a positional offset from a normal distribution of offset values and apply the positional offset to the location of each terrain point included in a simulated map scan to generate modified map scan data. The introduction of noise and offsets into map scans 210 and/or proprioception data 220 presented to the actor model improves the actor model's robustness against noisy proprioception observations and also improves the actor model's robustness against sensor drift during terrain scanning.

In various embodiments, perturbation module 420 may also introduce simulated robot motion disturbances into the modified proprioception data provided to the actor model to further improve the actor model's robustness. For example, perturbation module 420 may simulate a pushing force against the robot by introducing a momentary twist in the robot's torso. The second stage training may also improve the actor model's performance under varying payload and friction conditions by introducing into the modified proprioception data, via perturbation module 420, random variations in the mass of the robot torso and/or the friction coefficient of each robot foot. While concatenation module 240 received ground truth proprioception data 220 during the first stage training, during the second stage training, concatenation module 240 receives noisy or otherwise uncertain modified robot proprioception data from perturbation module 420, as shown by connector “A” in FIG. 4.

During the second stage training, map scans 210 may also include simulated map scans representing more challenging terrains than those included in the first stage training. For example, map scans 210 may include more complicated paths through terrain, fewer suitable footholds, and/or larger gaps between terrain elements. Similar to the first stage training, each of the various terrains included in map scans 210 may include an associated difficulty level, and a simulated robot may transition from one terrain to a different terrain having a higher or lower difficulty level than the previous terrain, based on the simulated robot's performance on the previous terrain. The second stage training may train a large number, e.g., 4,096, of simulated robots simultaneously through parallel execution of multiple processors and/or processing threads. Stage two training may continue for a predetermined number of epochs, e.g., 3,600 epochs. Controller 122 may iteratively modify one or more adjustable parameters included in, e.g., encoder 230 or actor MLP 250 based on the weighted sum of reward terms calculated by reward module 270 and future reward 295 generated by critic MLP 290. Critic model 280 may also iteratively modify one or more adjustable parameters included in critic MLP 290 based on future reward 295, one or more values generated by reward module 270, and proprioception data 220. At the conclusion of the second stage training, controller 122 is operable to generate fine-tuned action(s) 430 that allow a robot to successfully traverse diverse instances of difficult terrain, potentially based on noisy terrain and/or proprioception observations and with unexpected robot motion disturbances.

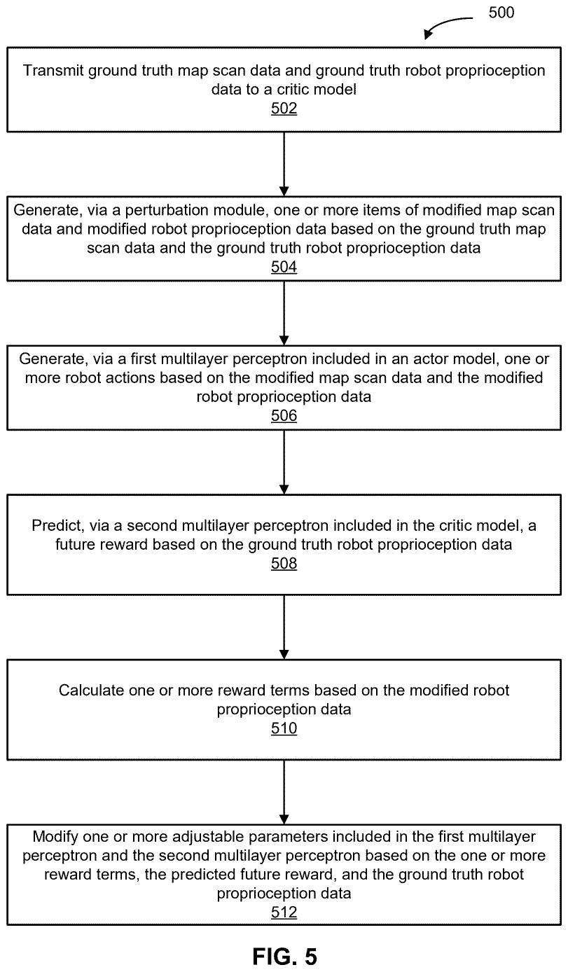

FIG. 5 is a flow diagram of method steps for fine-tuning a controller to generate robot actions, according to some embodiments. Although the method steps are described in conjunction with the systems of FIGS. 1-4, persons skilled in the art will understand that any system configured to perform the method steps in any order falls within the scope of the present disclosure.

As shown, in step 502 of method 500, controller 122 transmits ground truth map scans 210 and proprioception data 220 included in fine-tuning environment 400 to critic model 280. A map scan included in map scans 210 describes an instance of terrain, while proprioception data 220 describes robot sensor data, such as positions, orientations, torques, forces, velocities, external movement commands, and/or accelerations associated with simulated robot joints and/or limbs. During training, controller 122 performs the role of an actor model. Critic model 280 and the actor model share encoder 230 and concatenation module 240 shown in FIG. 2. While actor MLP 250 of controller 122 generates robot actions 260, critic MLP 290 of critic model 280 predicts future reward 295 based on proprioception data 220. Because proprioception data 220 is influenced by fine-tuned actions 430 generated by the actor model, future reward 295 predicted by critic MLP 290 represents an evaluation of the actor model's performance by critic model 280.

In step 504, controller 122 generates, via perturbation module 420, one or more items of modified map scan data and/or modified robot proprioception data, based on ground truth map scans 210 and proprioception data 220. In various embodiments, perturbation module 420 may introduce randomly generated noise or map drift into one or more items of proprioception data 220 and/or map scans 210 included in fine-tuning environment 400 to generate modified proprioception data and/or modified map scan data. For example, perturbation module 420 may randomly sample noise from a uniform distribution and add the sampled noise to an item of proprioception data 220. In various embodiments, perturbation module 420 may only modify a subset of proprioception data 220, and may leave other items of proprioception data 220 unchanged, such as robot velocities or previously generated fine-tuned actions 430. Perturbation module 420 may randomly sample a drift offset value from a normal distribution of offset values, and apply the sampled drift offset to a map scan included in map scans 210.

In step 506, actor MLP 250 of controller 122 (the actor model) generates one or more fine-tuned actions 430, based on the modified map scan data and/or the modified robot proprioception data. Controller 122 applies the modified map scan data and/or robot proprioception data to encoder 230 that generates map encoding 340. Map encoding 340 includes a collection of terrain points based on the map scan data, where each terrain point is associated with an attention weight representing an amount of attention paid to the terrain point by multi-head attention (MHA) mechanism 330 of encoder 230. MHA mechanism 330 determines the amount of attention paid to each terrain point based on map features 350 generated by controller 122, conditioned on an embedding of proprioception data 220 generated by linear embedding layer 310. The one or more fine-tuned actions 430 may include control commands directed to a robot and instructing the robot to modify positions, orientations, and/or movements associated with one or more limbs or joints included in the robot.

In step 508, critic MLP 290 included in critic model 280 predicts future reward 295 based on proprioception data 220, including previous fine-tuned actions 430 generated by actor MLP 250. The operation of critic model 280 is similar to that of the actor model, except that critic model 280 processes ground truth map scans 210 and proprioception data 220, rather than the noisy, uncertain, and/or offset modified data calculated by perturbation module 420 and processed by actor MLP 250.

In step 510, reward module 270 calculates one or more reward terms based on proprioception data 220. The reward terms may be directed to one or more of task-related robot performance, robot joint restrictions/regulations, or style rewards. The various reward terms encourage smooth robot motion, minimal foot slippage, maintaining joint positions, velocities, and/or torque values within specified limits, minimal collisions between the robot and the terrain, and minimal deviations from commanded angular and/or linear robot velocities.

In step 512, controller 122 modifies one or more adjustable parameters included in controller 122, based on the one or more reward terms generated by reward module 270 and future reward 295 predicted by critic MLP 290. In various embodiments, controller 122 modifies CNN 300, linear embedding layer 310, and MHA mechanism 330 that are shared by both the actor model and critic model 280, as well as actor MLP 250. Critic model 280 may modify one or more adjustable parameters included in critic MLP 290, based on the one or more reward terms generated by reward module 270, proprioception data 220, and/or future reward 295. Controller 122 and critic model 280 may continue training various components included in controller 122 and critic model 280 for a predetermined number of epochs, such as 3,600 epochs. Various embodiments of the present invention may instantiate a large number, e.g., 4,096, of simulated robots and train the simulated robots simultaneously via parallel execution of multiple processors and/or processing threads.

In sum, the disclosed techniques train a robot controller to generate robot locomotion actions based on a map scan of an environment associated with a robot and proprioception data associated with the robot. The robot controller generates local map features associated with multiple terrain points based on the map scan. A multi-head attention (MHA) mechanism included in the controller generates a map encoding based on the local map features, conditioned on proprioception data associated with the robot. The map encoding includes attention weights associated with each of multiple terrain points included in the map scan. These attention weights may be overlaid onto a visual representation of the robot's environment to visualize which terrain points received the most attention from the MHA mechanism during a particular time step. The terrain points receiving the most attention may represent suitable footholds for the robot during subsequent time steps. Based on the map encoding and robot proprioception data, a multilayer perceptron (MLP) included in the controller generates robot action commands.

The disclosed techniques include a multi-stage training technique having a first stage and a second stage. During each stage, the robot controller serves as an actor model, while a critic model includes the same component architecture as the actor model, except that an MLP included in the critic model predicts a future reward associated with robot actions predicted by the actor model, rather than predicting robot action commands. In each stage, the actor model is iteratively trained end-to-end based on the future reward predicted by the critic MLP and one or more reward terms based on robot actions predicted by the controller. The reward terms incentivize smooth robot movements within prescribed robot, joint, and/or limb limits. The reward terms also penalize conditions such as collisions between the robot and terrain, incorrect linear and/or angular robot velocities, large changes in commanded robot actions during consecutive time steps, foot slippage, excessive weight placed on a single robot limb, or jumping gaits in which none of a robot's limbs are in contact with the terrain at a particular time.

During the first training stage, both the actor model and the critic model receive ground truth map scans and robot proprioception data, simulating perfect sensing of the robot's environment and components. The first stage training iteratively modifies adjustable parameters included in both the actor and critic models based on reward terms calculated from the current robot state, predicted future rewards generated by the critic model, and robot proprioception data.

During the second training stage, the critic model continues to receive ground truth map scans and robot proprioception data, while the actor model receives noisy observations to simulate imperfect sensing of the robot's environment and/or proprioception data. For example, a perturbation module may sample random noise from a uniform distribution and add the noise to each observation in the robot proprioception data, while optionally leaving robot velocity measurements and/or previous robot action commands unperturbed. The perturbation module may also introduce drift into a map scan by randomly selecting an offset value from a normal distribution of values and shifting each terrain point in the map scan by the selected offset value to simulate degraded robot terrain sensing. The second stage training iteratively modifies the adjustable parameters included in both the actor and critic models using the same training techniques as in the first stage of training. Executing the actor model on degraded map and/or robot proprioception data while modifying adjustable model parameters based on executing the critic model on ground truth, unperturbed data improves the actor model's robustness against noisy inputs. To further improve the actor model's capabilities, the second training stage may also include map scans representing more difficult terrain compared to the map scans used in the first training stage.

In operation, a controller generates, during each of multiple inference time steps, robot action commands based on a map scan and robot proprioception data associated with the time step. The map scan may represent a portion of the robot's environment, and may include an (L×W) grid of terrain points, where each terrain point includes three associated x, y, and z coordinate values. The dimensionality of the map scan may therefore be (L×W×3). The robot proprioception data may include current state values associated with the robot, as well as external robot action commands and/or robot action commands generated by the controller during a previous time step. The robot state values may include positions, orientations, forces, velocities, and/or accelerations associated with one or more robot limbs or joints.

The controller includes an encoder that receives the map scan and robot proprioception data. A convolutional neural network (CNN) included in the controller receives and processes a reduced-dimensionality (L×W×1) map scan that includes only the z (height) coordinate associated with each of the (L×W) terrain points. The CNN embeds point-wise local terrain features into a robot-centric elevation map derived from the reduced-dimensionality, height-only version of the map scan.

The encoder concatenates the reduced-dimensionality elevation map with the full-dimensionality (L×W×3) map scan and generates embedded map features for each of the (L×W) terrain points. The encoder transmits the embedded features to a multi-head attention (MHA) mechanism as key-value pairs, where a value represents a terrain point and a corresponding key represents the embedded features associated with the terrain point.

A linear encoding layer encodes the robot proprioception data into a query and transmits the query to the MHA mechanism. At each time step, the MHA mechanism identifies keys (embedded map features) that are most relevant to the query, and updates attention weights associated with each of the values (terrain points) corresponding to the identified keys. Terrain points including higher attention weights may represent suitable robot footholds. The MHA mechanism generates a map encoding that represents the terrain points and associated attention weights. A visual display may include a depiction of the robot and the surrounding environment, with the attention weights associated with terrain points displayed as attention indicators, based on the map encoding generated by the MHA mechanism. The color, shape, size, and/or other characteristics of an individual attention indicator may represent an amount of attention paid to the terrain point by the MHA mechanism.

The controller concatenates the map encoding generated by the MHA mechanism with the robot proprioception data and transmits the concatenated data to a multilayer perceptron (MLP) included in the controller. The MLP generates robot action commands based on the map encoding and the robot proprioception data. For example, the robot action commands may include one or more joint movement commands that cause the robot to move toward a terrain point identified as a suitable foothold based on the terrain point's associated attention weight.

The controller is trained during a two-stage training process, where the controller serves as an actor model. A critic model includes a similar architecture as the controller, including several components that are shared between the critic and actor models. However, the MLP associated with the critic model may predict a future reward value based on robot actions generated by the controller MLP and the actions'effects on the robot proprioception data.

During the first training stage, both the actor model and the critic model are provided with ground truth map scan and robot proprioception data, simulating perfect sensing by the robot. A reward module calculates values for reward terms directed to tasks, regulation, and style, based on the robot actions generated by the actor model. For example, task-related reward terms may evaluate linear and angular robot velocities for deviations from commanded values, as well as penalizing early termination of a robot task or collisions between the robot and the terrain. Regulation-related reward terms may penalize abrupt changes in commanded robot actions during consecutive time steps. Regulation-related reward terms may also penalize large joint acceleration and/or joint torque, values, in addition to penalizing joint position, velocity, acceleration, and/or torque values that approach or exceed predetermined limits. Style-related reward terms may reward smooth robot motions that include small linear or angular velocities, as well as robot motions that maintain the robot in a straight, upright orientation. Style-related reward terms may penalize motions that cause the robot to place an excessive amount of weight on one limb, or that cause a jumping gait where, at a particular time, none of the robot limbs are in contact with the terrain. Style-related reward terms may also penalize foot slippage by detecting limbs that are in contact with the ground while exhibiting a non-zero velocity.

The critic model predicts a future reward value based on the robot actions generated by the actor model. Based on the reward terms and future reward value, the training modifies one or more adjustable parameters included in the actor and critic models. The first stage training may continue for a predetermined number of epochs. The first stage training may include relatively simple terrain types that, when paired with the simulated perfect perception of map and proprioception data, prepare the encoder and controller MLP to analyze basic terrain types and generate suitable robot action commands to traverse the terrain.

During a second stage of training, the map scans represent more challenging terrain types than those presented during the first stage training. Additionally, both the map scan data and robot proprioception data analyzed by the actor model may be modified with randomly generated noise and/or map offsets to simulate imperfect robot sensing, while the critic model continues to analyze ground truth map scan and proprioception data. As with the first stage training, the second stage training modifies adjustable actor and critic model parameters based on reward terms calculated from robot proprioception data and future reward values generated by the critic model. The second stage training may continue for a predetermined number of epochs that may be the same as or different than the number of epochs used during first stage training. By presenting noisy map and proprioception data to the actor model, while providing ground truth map and proprioception data to the critic model, the second stage training improves the robustness of the actor model against noisy inputs.

One technical advantage of the disclosed techniques relative to the prior art is that the disclosed techniques generate robot actions that enable a robot to dynamically navigate diverse terrain types, including terrains that include sparsely distributed footholds. The disclosed techniques are also operable to generate precise robot behaviors in novel scenarios, while exhibiting robustness against uncertain inputs and/or environmental conditions. These technical advantages provide one or more improvements over prior art approaches.

1. In some embodiments, a computer-implemented method for generating robot action commands, the computer-implemented method comprises generating embedded map features based at least on a three-dimensional (3D) representation of a terrain, generating a query based at least on robot proprioception data, generating, using multi-head attention and based at least on the query and the embedded map features, attention weights associated with a plurality of terrain points included in the terrain, and generating one or more robot action commands based at least on the attention weights and the robot proprioception data.

2. The computer-implemented method of clause 1, further comprising displaying attention indicators associated with one or more of the attention weights, wherein the attention indicators are displayed within a rendered or augmented reality depiction of a 3D environment that includes the terrain.

3. The computer-implemented method of clauses 1 or 2, wherein the robot proprioception data includes one or more positions, velocities, accelerations, or orientations associated with a robot.

4. The computer-implemented method of any of clauses 1-3, wherein the embedded map features are expressed as a plurality of key-value pairs.

5. The computer-implemented method of any of clauses 1-4, wherein a value included in a key-value pair is associated with a terrain point included in the plurality of terrain points, and a key included in the key-value pair represents local terrain features associated with the terrain point.

6. The computer-implemented method of any of clauses 1-5, wherein an attention weight associated with the terrain point is based at least on a relevance of the key associated with the terrain point to the query.

7. The computer-implemented method of any of clauses 1-6, wherein the one or more robot action commands are generated by a first multilayer perceptron (MLP), further comprising predicting, via a second MLP, a future reward based at least on the one or more robot action commands.

8. The computer-implemented method of any of clauses 1-7, further comprising training the first MLP and the second MLP using ground truth map scan data and ground truth robot proprioception data, wherein the training is performed during a first training stage.

9. The computer-implemented method of any of clauses 1-8, further comprising training (i) the first MLP, using modified map scan data and modified robot proprioception data and (ii) the second MLP, using ground truth map scan data and ground truth robot proprioception data, wherein the training is performed during a second training stage.

10. The computer-implemented method of any of clauses 1-9, further comprising adding randomly sampled noise to one or more items of robot proprioception data included in the ground truth robot proprioception data to generate the modified robot proprioception data, and adding a randomly sampled positional offset to one or more terrain point locations included in the ground truth map scan data to generate the modified map scan data.

11. The computer-implemented method of any of clauses 1-10, wherein the robot proprioception data includes one or more previously generated robot action commands.

12. The computer-implemented method of any of clauses 1-11, further comprising predicting a foothold for a robot based at least on the attention weights, wherein the robot action commands direct the robot to the foothold.

13. In some embodiments, one or more non-transitory computer-readable media store instructions that, when executed by one or more processors, cause the one or more processors to perform the steps of generating embedded map features based at least on a three-dimensional (3D) representation of a terrain, generating a query based at least on robot proprioception data, generating, using multi-head attention and based at least on the query and the embedded map features, attention weights associated with a plurality of terrain points included in the terrain, and generating one or more robot action commands based at least on the attention weights and the robot proprioception data.

14. The one or more non-transitory computer-readable media of clause 13, wherein the robot proprioception data includes one or more positions, velocities, accelerations, or orientations associated with a robot.

15. The one or more non-transitory computer-readable media of clauses 13 or 14, wherein the embedded map features are expressed as a plurality of key-value pairs.

16. The one or more non-transitory computer-readable media of any of clauses 13-15, wherein a value included in a key-value pair is associated with a terrain point included in the plurality of terrain points, and a key included in the key-value pair represents local terrain features associated with the terrain point.

17. The one or more non-transitory computer-readable media of any of clauses 13-16, wherein an attention weight associated with the terrain point is based at least on a relevance of the key associated with the terrain point to the query.

18. In some embodiments, a system comprises one or more memories storing instructions, and one or more processors for executing the instructions to generate embedded map features based at least on a three-dimensional (3D) representation of a terrain, generate a query based at least on robot proprioception data, generate, using multi-head attention and based at least on the query and the embedded map features, attention weights associated with a plurality of terrain points included in the terrain, and generate one or more robot action commands based at least on the attention weights and the robot proprioception data.

19. The system of clause 18, further comprising displaying attention indicators associated with one or more of the attention weights.

20. The system of clauses 18 or 19, wherein the attention indicators are displayed within a rendered or augmented reality depiction of a 3D environment that includes the terrain.

Any and all combinations of any of the claim elements recited in any of the claims and/or any elements described in this application, in any fashion, fall within the contemplated scope of the present invention and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating robot action commands, the computer-implemented method comprising:
generating embedded map features based at least on a three-dimensional (3D) representation of a terrain;
generating a query based at least on robot proprioception data;
generating, using multi-head attention and based at least on the query and the embedded map features, attention weights associated with a plurality of terrain points included in the terrain; and
generating one or more robot action commands based at least on the attention weights and the robot proprioception data.

2. The computer-implemented method of claim 1, further comprising displaying attention indicators associated with one or more of the attention weights, wherein the attention indicators are displayed within a rendered or augmented reality depiction of a 3D environment that includes the terrain.

3. The computer-implemented method of claim 1, wherein the robot proprioception data includes one or more positions, velocities, accelerations, or orientations associated with a robot.

4. The computer-implemented method of claim 1, wherein the embedded map features are expressed as a plurality of key-value pairs.

5. The computer-implemented method of claim 4, wherein a value included in a key-value pair is associated with a terrain point included in the plurality of terrain points, and a key included in the key-value pair represents local terrain features associated with the terrain point.

6. The computer-implemented method of claim 5, wherein an attention weight associated with the terrain point is based at least on a relevance of the key associated with the terrain point to the query.

7. The computer-implemented method of claim 1, wherein the one or more robot action commands are generated by a first multilayer perceptron (MLP), further comprising predicting, via a second MLP, a future reward based at least on the one or more robot action commands.

8. The computer-implemented method of claim 7, further comprising training the first MLP and the second MLP using ground truth map scan data and ground truth robot proprioception data, wherein the training is performed during a first training stage.

9. The computer-implemented method of claim 7, further comprising training (i) the first MLP, using modified map scan data and modified robot proprioception data and (ii) the second MLP, using ground truth map scan data and ground truth robot proprioception data, wherein the training is performed during a second training stage.

10. The computer-implemented method of claim 9, further comprising:
adding randomly sampled noise to one or more items of robot proprioception data included in the ground truth robot proprioception data to generate the modified robot proprioception data; and
adding a randomly sampled positional offset to one or more terrain point locations included in the ground truth map scan data to generate the modified map scan data.

11. The computer-implemented method of claim 1, wherein the robot proprioception data includes one or more previously generated robot action commands.

12. The computer-implemented method of claim 1, further comprising predicting a foothold for a robot based at least on the attention weights, wherein the robot action commands direct the robot to the foothold.

13. One or more non-transitory computer-readable media storing instructions that, when executed by one or more processors, cause the one or more processors to perform the steps of:
generating embedded map features based at least on a three-dimensional (3D) representation of a terrain;
generating a query based at least on robot proprioception data;
generating, using multi-head attention and based at least on the query and the embedded map features, attention weights associated with a plurality of terrain points included in the terrain; and
generating one or more robot action commands based at least on the attention weights and the robot proprioception data.

14. The one or more non-transitory computer-readable media of claim 13, wherein the robot proprioception data includes one or more positions, velocities, accelerations, or orientations associated with a robot.

15. The one or more non-transitory computer-readable media of claim 13, wherein the embedded map features are expressed as a plurality of key-value pairs.

16. The one or more non-transitory computer-readable media of claim 15, wherein a value included in a key-value pair is associated with a terrain point included in the plurality of terrain points, and a key included in the key-value pair represents local terrain features associated with the terrain point.

17. The one or more non-transitory computer-readable media of claim 16, wherein an attention weight associated with the terrain point is based at least on a relevance of the key associated with the terrain point to the query.

18. A system comprising:
one or more memories storing instructions; and
one or more processors for executing the instructions to:
generate embedded map features based at least on a three-dimensional (3D) representation of a terrain;
generate a query based at least on robot proprioception data;
generate, using multi-head attention and based at least on the query and the embedded map features, attention weights associated with a plurality of terrain points included in the terrain; and
generate one or more robot action commands based at least on the attention weights and the robot proprioception data.

19. The system of claim 18, further comprising displaying attention indicators associated with one or more of the attention weights.

20. The system of claim 19, wherein the attention indicators are displayed within a rendered or augmented reality depiction of a 3D environment that includes the terrain.
